(19) United States
(12) Patent Application Publication
(10) Pub. No.: US 2024/0269697 A1
(43) Pub. Date: Aug. 15, 2024

(54) DISPENSER/REFILL PACKAGE

(71) Applicant: Eric ZEMBROD, Botucatu (BR)

(72) Inventor: Eric ZEMBROD, Botucatu (BR)

(21) Appl. No.: 18/568,421

(22) PCT Filed: Jun. 8, 2021
(86) PCT No.: PCT/BR2021/050246

§ 371 Date: Dec. 8, 2023

(51) Int. Cl. B05B 11/00; B65D 83/22

(52) U.S. Cl. CPC B05B 11/0097; B05B 11/0027; B65D 83/22

(57) ABSTRACT

DISPENSER/REFILL PACKAGE, of the type to receive a dispenser/refill (E), cylindrical, ordinarily consisting of a pot (P) and a dispensing head in the form of a button (B) with a side outlet (S) in the form of a single hole or, where applicable, in the form of a spout, also having an elevator ring (1), the inner diameter of which constitutes a fitting with interference for a usual dispenser/refill (E), while its outer diameter is fitted slipwise into the inner diameter of a circular collar (2) which, in turn, is fitted to the top of a cylindrical cup (3), where it is free to semi-rotate in both directions in conjunction with a cam system (4) configured in the elevator ring (1), circular collar (2) and cylindrical cup (3), so that when the circular collar (2) is semi-rotated, clockwise or counterclockwise, the elevator ring (1) can be moved up or down together with the dispenser/refill (E).

### FIELD OF INVENTION

The present Invention refers to permanent or reusable dispenser, with a cylindrical shape, having the means to receive, by simple fitting, a disposable dispenser/refill of the dispenser type, normally used to pack and serve small quantities of different products in a state of easy fluidity, for example: cosmetics, pharmaceuticals and others.

### STATE OF THE ART

Currently, a peculiar type of packaging with a dispensing mechanism, widely used for certain products that must be ejected in small quantities, such as, for example, cosmetics and pharmaceuticals, all in a state of easy fluidity.

There is a considerable variety of this type of dispenser that, in general terms, includes a reservoir, a dispensing head and in the latter a suitable outlet point for the product, in the form of a hole or spout. Normally, the dispensing head has an internal mechanism formed by a small pump and at least one valve, both actuated by the upper part of the dispensing head, which, in turn, is in the form of a button that, when pressed, causes a small amount of product to be ejected through an outlet or a nozzle.

Such dispenser is usually disposable and, therefore, it was noted that many details must prevail so that the set can have an appearance that, in addition to suggesting the good quality of the dispensed product, must reflect an exquisite look, which ends up considerably increasing the final cost of the set that, in the end, is discarded.

Currently the trend is to keep such dispenser with the characteristic of being totally disposable and recyclable, however, in the form of refill and, for that, there are already cases that allow the use of such “DISPENSER/REFILL PACKEGE”, equally developed to be disposable and, many of them, even meet the ecological obligations to be recycled, however, in this case the dispensing packaging does not need to have an inviting external finish or one that suggests the good quality of the product, as such details of visual enrichment are totally concentrated in the external details of the “CASE” which, in turn, is the permanent and reusable part of the set.

Another advantage of the reusable case is the versatility of having a single case for different ejected products, that is, the same case with slight variations in printing and other informative details can be used, for example, for different dispensers/refills of cosmetic products that use the same disposable packaging.

As already mentioned, the state of the art currently provides information on some cases specially created for the above purpose, as taught in the following documents: CN204444654, EP2893833, EP3023027, EP3178349, TW201601661, TWM462541, TWM582791, TWM488241, TWM495768, TWM520303, U.S. Pat. No. 9,186,689, U.S. Ser. No. 00/993,0953, US20140086661, US20150102123 and US20160037890.

There is no doubt that the dispensers taught in such documents allow the advantageous use of a dispenser/refill, however, it was observed that the means used for this purpose require the use of many components, knowing devices with up to seven components are known, some of them made with two or more parts of metallic materials, which generates complex cases, not only with regard to the assembly of the set, but also in terms of operation and, in the end, the cost of the set ends up extrapolating the desired parameters, and the versions with metallic materials are difficult and costly to be recycled, not meeting the much desired characteristic of being an environmentally friendly product.

### Objectives of the Invention

The main purpose of the invention is a specially designed case with only three monomaterial components, such as plastics in general, including biodegradable ones, being a static part that constitutes the main body, and two moving parts, one of which is a circular collar, concentrically attached to the upper part of the main body, where it is free to semi-rotate in both directions, while the other is an elevator ring, internal and concentric, where its internal diameter receives the dispenser/refill by simple fitting with smooth interference, while by the external diameter said elevator ring, in addition to sliding up and down the internal diameter of the circular collar, it presents follower projections that are interlocked with a cam system configured in the corresponding parts of the said main body and the said circular collar, so that, when the latter is rotated, causes the dispenser/refill to be moved up or down, exposing or retracting its upper end, the one in the form of a dispensing head, keeping it in position to be pressed and eject a certain amount of product, or to be completely retracted to avoid unwanted activation when the case is at rest.

Therefore, only three components of mono plastic material define the dispenser in question, even without the use of metal parts, translating a simple device, in terms of manufacture and operation, since, in addition to being completely manufactured in monomaterial, its assembly is really simplified only with fitting between the three components, including not using any metal component or additional fastening component, making it an environmentally friendly product, since its recycling is facilitated, not only because it is a mono-material set, but also because it has a reduced number of components.

### DESCRIPTION OF THE DRAWINGS

For a better understanding of this Invention, a detailed description of it is given below, making references to the attached drawings:

FIG. 1 represents an upper-angle view of the case without the dispenser/refill;

FIG. 2 shows an upper-angle view of the case with the dispenser/refill;

FIG. 3 illustrates an exploded view at an upper angle showing the details that make up the case in question;

FIG. 4 is also a view in an exploded perspective, but at a lower angle showing other details of the components that make up the case in question;

FIG. 5 is a sectional view indicated in FIG. 2, showing the case with the dispenser/refill in the retracted position in the package (in this view the refill package was not shown in a cut because it is a usual set);

FIG. 6 represents the same section of the previous figure, however, in this case, showing the case with the dispenser/refill positioned outside the package (in this view the packaging/refill was also not shown in section);

FIG. 7 is a perspective view showing the assembly at an upper angle and the dispenser/refill moved outwards; and the

FIG. 8 shows a perspective view showing the assembly at a top angle and the dispenser/refill removed from the package.

### DETAILED DESCRIPTION OF THE INVENTION

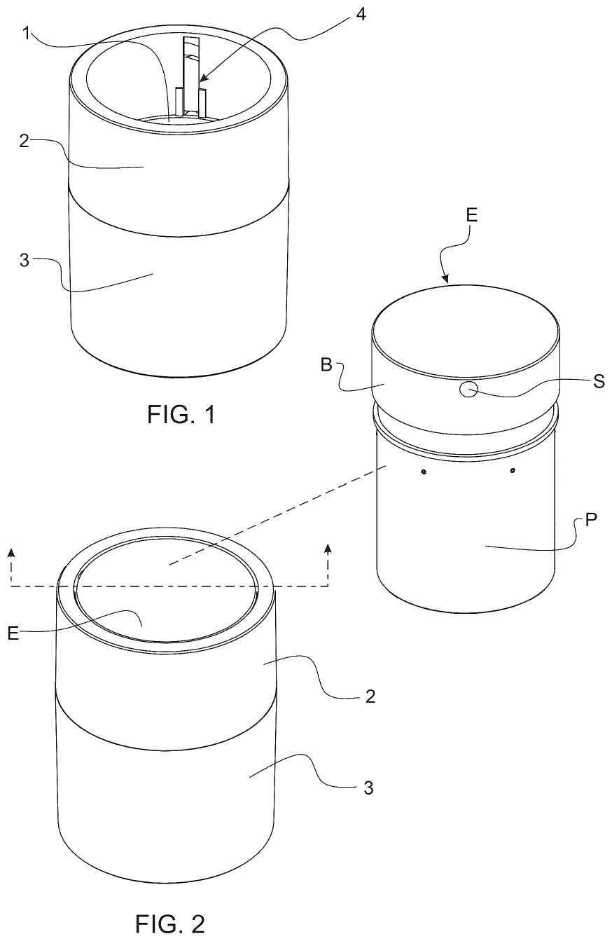

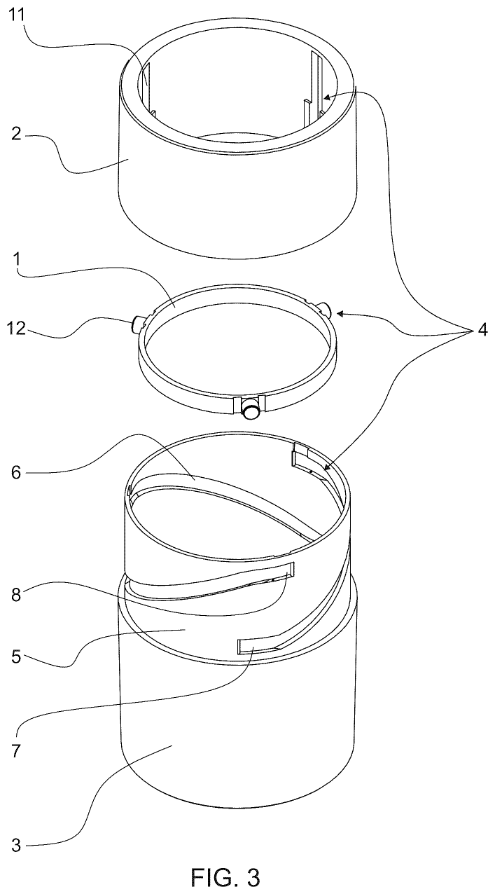

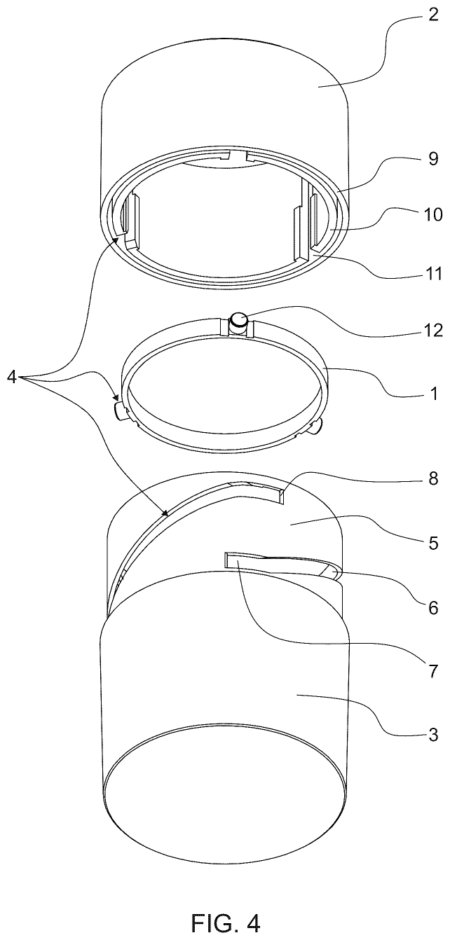

According to these illustrations and their details, more particularly FIGS. 1 to 5, the present Invention, DISPENSER/REFILL PACKAGE, is of the type to receive a dispenser/refill (E), cylindrical, ordinarily consisting of a pot (P) and a dispensing head in the form of a button (B) with a lateral outlet (S) in the form of a simple hole or, where applicable, in the form of a nozzle (not illustrated).

The present invention is characterized by comprising an elevator ring (1), whose internal diameter constitutes a fitting with interference for a dispenser/refill (E), usual and cylindrical, while its external diameter is slidably fitted in the internal diameter of a circular collar (2) which, in turn, is fitted to the upper part of a cylindrical cup (3), where it is free to semi-rotate in both directions in conjunction with a cam system (4) configured in the elevator ring (1), circular collar (2) and cylindrical cup (3), so that when the said circular collar (2) is semi-rotated, clockwise or counterclockwise, the elevator ring (1) can be moved up or down together with the dispenser/refill (E).

The cam system (4) is initially formed in the upper wall section (5) of the cylindrical cup (3) which, for this purpose, presents this wall section preferably with a smaller thickness and has the cam itself in the form of inclined slots (6) with lower (7) and upper (8) stop tops.

The section of wall with a smaller thickness (5) is inserted by a simple fitting from bottom to top in the circular collar (3) which, for this purpose, is formed by concentric walls spaced and unified at the upper ends, but separated at the lower ends, being an external wall (9) and an internal wall (10), the latter with vertical slots (11), where short follower pins (12) penetrate radially from the external diameter of the said elevator ring (1), follower pins (12) that also pass through the inclined slots (6), so that when semi-turning is applied to the said circular collar (2) in clockwise or counterclockwise directions, the follower pins (12) slide into the cam slots (6) and, thus, the said elevator ring (1) is moved up or down together with the dispenser/refill (E).

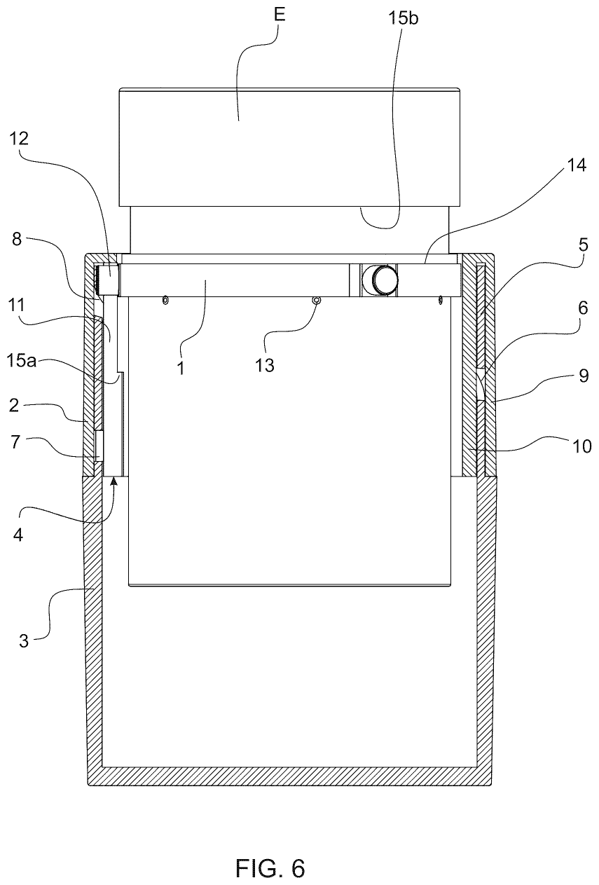

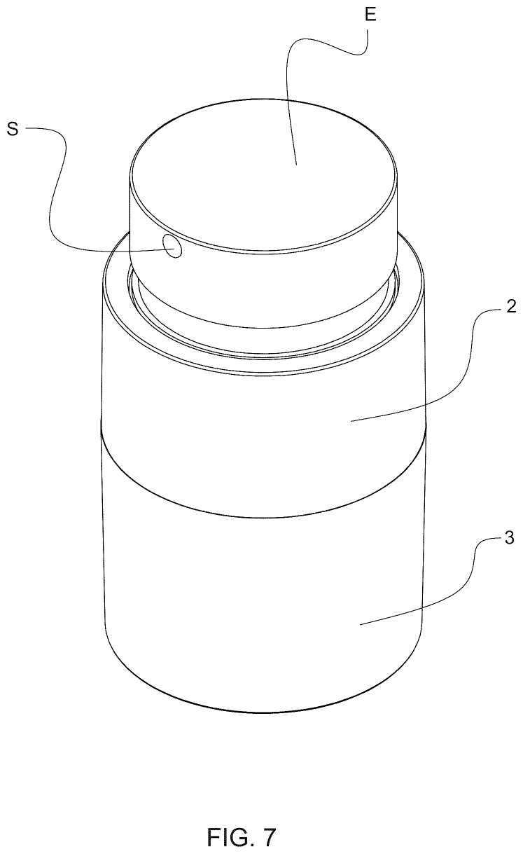

FIGS. 6 and 7 show the dispenser/refill moved outwards, where it can be seen that, in this position, its button-shaped head is exposed enough to be pressed and, as a result, a certain amount of product is ejected through the outlet (S). Once this is done, to pick up the dispenser/refill package, just activate the circular collar (2) again in the opposite direction.

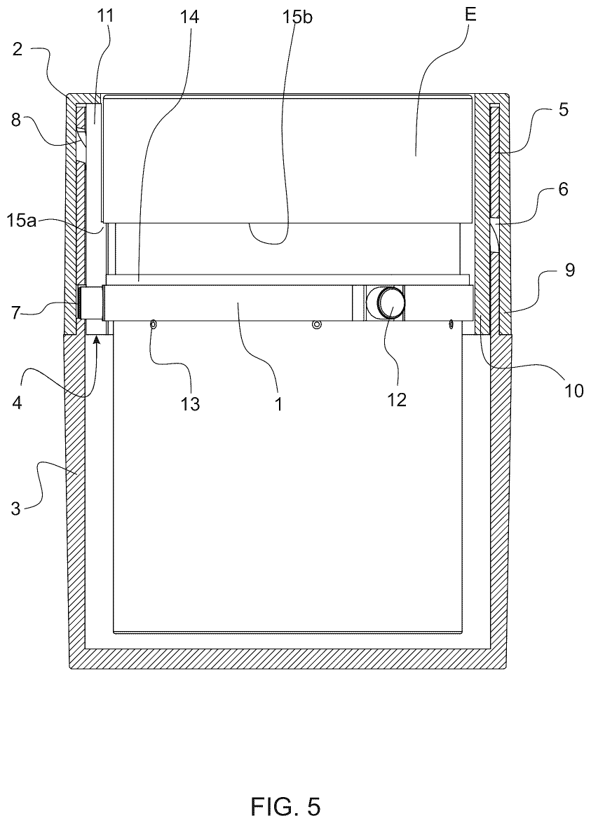

FIGS. 5 and 6 show that the circular collar (2) has internally inward-facing radial projections that configure support stops (15a) for the dispensing head in the form of a button (B) when it is retracted and, for this purpose, the dispensing head in the form of a button (B) has an external diameter greater than the external diameter of its pot (P), forming on its lower edge a support step (15b) cooperating for that, in the retracted position of the button (B), such support steps (15a and 15b) prevent the button (B) from being accidentally operated when the assembly is not in use.

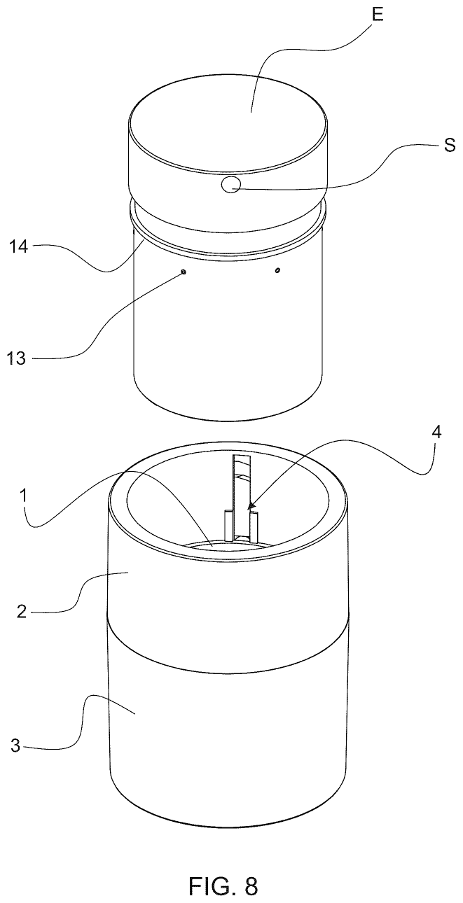

FIG. 8 shows that to replace the dispenser/refill (E) with a refill, simply pull it up until it is completely released and then insert the refill, after which the set is ready to be used.

As already mentioned, the dispenser/refill package (E) is inserted with interference inside the elevator ring (1) and, for this purpose, the package must present details (13), in the form of a protrusion or cooperating protruding fillet to provide adequate interference and slight locking below the elevator ring (1), sufficient to keep the said dispenser/refill package smoothly locked, to prevent it from coming off easily when handling the set or when it is accidentally held upside down.

On the other hand, the dispenser/refill (E) also includes a flange or any equivalent projection in continuous or non-continuous form, which configures a stop step (14) which, together with the elevator ring (1), configures a penetration limiter of the dispenser/refill (E), so that, once the fitting is complete, the said elevator ring (1) is positioned between the stop step (14) and the detail (13) of interference, providing a smooth locking of said dispenser/refill.

It will be understood that certain characteristics and combinations of the dispenser/refill package (E) in relation to the case can vary considerably while maintaining the same functional concept, consequently, it is noted that the construction described here in detail as an example is clearly subject to constructive variations, however, always within the scope of the inventive concept now revealed of a case with only three pieces and as many modifications can be made in the accordance with the descriptive requirements of the law, it is understood that the details present should be interpreted as illustrative and not limiting.

1. DISPENSER/REFILL PACKAGE, of the type to receive a pack/refill (E), cylindrical, ordinarily consisting of a pot (P) and a dispensing head in the shape of a button (B) with a lateral outlet (S) in the form of a single hole or, where applicable, in the form of a nozzle, characterized by the fact that it comprises an elevator ring (1), whose internal diameter constitutes a fitting with interference for a usual dispenser/refill (E), while its external diameter is slidably fitted in the internal diameter of a circular collar (2) which, in turn, is fitted to the upper part of a cylindrical cup (3), where it is free to semi-rotate in both directions in conjunction with a cam system (4) configured in the elevator ring (1), circular collar (2) and cylindrical cup (3).

2. DISPENSER/REFILL PACKAGE, according to the claim 1, characterizing by the fact that the cam system (4) is initially formed in the upper wall section (5) of the cylindrical cup (3) which, for this purpose, presents this wall section with a smaller thickness and has the can itself in the form of inclined slots (6) with lower (7) and upper (8) stop tops; said section of wall with a smaller thickness (5) is inserted by a simple fitting from bottom to top in the circular collar (3) which, for this purpose, is formed by concentric walls spaced and unified at the upper ends, but separated at the lower ends, being an external wall (9) and an internal wall (10), the latter with vertical slots (11), where short follower pins (12) penetrate radially from the external diameter of the said elevator ring (1), follower pins (12) that also pass through the inclined slots (6).

3. DISPENSER/REFILL PACKAGE, according to the claim 2, characterized by the fact that the circular collar (2) has internally radial projections facing inwards that configure support stops (15a) for the dispensing head in the form of a button (B) when it is retracted and, for this purpose, the said dispensing head in the form of a button (B) has its external diameter greater than the external diameter of its pot (P), forming on its lower edge a cooperating support step (15b) so that, in the retracted position of the button (B), these support steps (15a and 15b) prevent the button (B) from being operated when the assembly is not in use.

4. DISPENSER/REFILL PACKAGE, according to claim 1, characterized by the fact that the dispenser (E) has details (13), in the form of a protrusion or cooperating protrusion filled to provide interference and slight locking below the elevator ring (1).

5. DISPENSER/REFILL PACKAGE, according to claim 1, characterized by the fact that the dispenser/refill (E) includes a flange or projection in continuous or non-continuous form, which configures a stop step (14) which, together with the elevator ring (1), configures a penetration limiter of the dispenser/refill package (E), so that, once the fitting is complete, the elevator ring (1) is positioned between the step stop (14) and any interference detail (13).
